(19) United States
(12) Patent Application Publication
(10) Pub. No.: US 2025/0390338 A1
(43) Pub. Date: Dec. 25, 2025

(54) EFFICIENT COMBINATORIAL METHOD FOR SCHEDULING A WORK PROCESS

(71) Applicant: INTERNATIONAL BUSINESS MACHINES CORPORATION, ARMONK, NY (US)

(72) Inventors: Kanthi Sarpatwar, Briarcliff Manor, NY (US); James Thomas Rayfield, Ridgefield, CT (US); Surya Shravan Kumar Sajja, Bangalore (IN); Roman Vaculin, Larchmont, NY (US); Stephane Michel, Roquefort les Pins (FR); Yuan Yuan Jia, BeiJing (CN)

(21) Appl. No.: 18/747,576

(22) Filed: Jun. 19, 2024

(51) Int. Cl. G06F 9/48

(52) U.S. Cl. CPC G06F 9/4881

(57) ABSTRACT

A method, computer program product, and computer system optimizing a scheduling instance for a work process and performing the work process in accordance with the optimized scheduling instance. A pool P of C candidate tasks of a work process is generated. The work process is characterized by an initial scheduling instance that includes tasks. A total of k output scenarios are generated, where k≥2. Each output scenario includes b tasks selected from the pool P, where b≥2. A modified schedule instance (MSI) for each output scenario is generated and key performance indicators (KPIs) associated with each MSI are generated. The generated MSIs and KPIs are outputted. One MSI of the generated MSIs is selected. The work process is performed in accordance with the selected one MSI, wherein the KPIs associated with the selected one MSI improve the work process.

### BACKGROUND

The present invention relates to scheduling a work process, and more specifically, to optimizing a scheduling instance for the work process and performing the work process in accordance with the optimized scheduling instance.

### SUMMARY

Embodiments of the present invention provide a method, a computer program product, and a computer system, for optimizing a scheduling instance for a work process and performing the work process in accordance with the optimized scheduling instance. One or more processors of a computer system generate a pool P of C candidate tasks of a work process characterized by an initial scheduling instance I that includes T tasks. Each task of the T tasks is a job to be performed and constraints associated with the job. C is at least 3 and T>C. The one or more processors generate k output scenarios. Each output scenario includes b tasks selected from the pool P, wherein b<C, b is at least 2, and k is at least 2. The one or more processors generate both a modified schedule instance (MSI) for each output scenario and key performance indicators (KPIs) associated with each MSI. The one or more processors output the generated MSIs and KPIs. The one or more processors select, or receive a selection of, one MSI of the generated MSIs. The one or more processors perform the work process in accordance with the selected one MSI. The KPIs associated with the selected one MSI improve the work process.

### BRIEF DESCRIPTION OF THE DRAWINGS

FIG. 1 depicts a system for scheduling a work process, in accordance with embodiments of the present invention.

FIG. 2 is a flow chart of an embodiment of a method for optimizing a scheduling instance for a work process and performing the work process in accordance with the optimized scheduling instance, in accordance with embodiments of the present invention.

FIG. 3 is a flow chart describing a first embodiment of a process for generating a pool of candidate tasks, in accordance with embodiments of the present invention.

FIG. 4 is a flow chart describing a second embodiment of a process for generating a pool of candidate tasks, in accordance with embodiments of the present invention.

FIG. 5 is a flow chart for generating output scenarios for a work process, in accordance with embodiments of the present invention.

FIG. 6A is a flow chart of a first version of a TopMarginalAnalysis algorithm, in accordance with embodiments of the present invention.

FIG. 6b is a flow chart of a second version of a TopMarginalAnalysis algorithm, in accordance with embodiments of the present invention.

FIG. 7 illustrates a computer system, in accordance with embodiments of the present invention.

FIG. 8 depicts a computing environment which contains an example of an environment for the execution of at least some of the computer code involved in performing the inventive methods, in accordance with embodiments of the present invention.

### DETAILED DESCRIPTION

According to an aspect of the invention, one or more processors of a computer system generate a pool P of C candidate tasks of a work process characterized by an initial scheduling instance I comprising T tasks. Each task of the T tasks is a job to be performed and constraints associated with the job. C is at least 3 and T>C. The one or more processors generate k output scenarios. Each output scenario includes b tasks selected from the pool P, wherein b<C, b is at least 2, and k is at least 2. The one or more processors generate both a modified schedule instance (MSI) for each output scenario and key performance indicators (KPIs) associated with each MSI. The one or more processors output the generated MSIs and KPIs. The one or more processors select, or receive a selection of, one MSI of the generated MSIs. The one or more processors perform the work process in accordance with the selected one MSI. The KPIs associated with the selected one MSI improve the work process.

The preceding aspect of the invention advantageously generates an optimized schedule instance for a work process and performs the work process in accordance with the optimized schedule instance in a improved manner due to key performance indicators (KPIs) associated with the optimized schedule instance.

In first embodiments, generating k output scenarios includes: receiving input of I, P, β, k, and b, where β is a blackbox optimizer; setting an array H to Null; performing an outer iterative process over outer iterations t from t=1 to t=b, where the outer iterative process includes: determining an array Hnew of subsets of tasks in P and a gain associated with each subset of tasks in Hnew, where determining the array Hnew is performed in dependence on I, β, k, and H; and setting H to be an array of k elements of Hnew that have the highest gains. After forming an outer iterative process, H is outputted. The outputted H is the k output scenarios.

In the first embodiments, determining the array H_{new} includes: setting H_{new} to Null; performing an inner iterative process over inner iterations j from j=1 to j=J, where J=SIZE(H), and wherein the inner iterative process comprises for iteration j (j=1, . . . , J): if H is Null then setting an array S to Null else setting S to S=H(j); performing TopMarginalAnalysis (I, P, β, k, S) which outputs an array M having k elements structured as M₁, . . . , Mₖ, where each element Mₙ of M is one or more tasks Qₙ in the pool P and an associated gain Gₙ (n=1, . . . , k); and updating H_{new} according to H_{new}=H_{new}∪{S+Qₙ∀Qₙ∈M}.

Also in the first embodiments, performing TopMarginalAnalysis (I, P, β, k, S) includes: receiving inputs I, P, β, k, and S; computing array Q via Q=S\textcircled{★}(P\S); computing and storing gain array G=β(I\\Q); Q=[Q₁, . . . , Q_{N}] and G=[G₁, . . . , G_{N}]; generating array M=[M₁, . . . , M_{N})]=[(Q₁,G₁), . . . , (Q_{N},G_{N})]; reorganizing M to retain only those elements Mₙ of M that have the top k gains in G, resulting in the reorganized array M consisting of k elements; and returning M.

The preceding first embodiments provide a technical feature of selectively iterating on tasks and scenarios of the work process, resulting in an outputting of multiple scenarios and a gain associated with each outputted scenario, where each gain is indicative of a degree of optimization of an associated scheduling instance of the work process.

In second embodiments, performing TopMarginalAnalysis (I, P, β, k, S) further includes: after said computing array Q and before said computing and storing gain array G, removing from Q each element of Q that was previously computed and stored.

The preceding second embodiments provide a technical feature of not performing duplicate blackbox optimizations, which reduces the computation time for generating the k output scenarios.

In third embodiments, generating the pool P of C candidate tasks includes: receiving a critical path of tasks; identifying a feature vector for each task on the critical path; applying cluster analysis to the feature vectors to generate multiple clusters of tasks; and generating the pool P of C candidate tasks from the generated multiple clusters.

The preceding third embodiments provide a technical feature of generating the pool P of C candidate tasks in a manner that selects the tasks in the pool based on a clustering of features of tasks on a critical path of the tasks. Thus, the generated pool of tasks includes fewer tasks, but most significant tasks, which enables the output scenarios of tasks to be generated more efficiently with reduced computation time.

In fourth embodiments, generating the pool P of C candidate tasks includes: extracting an initial set of tasks from the initial scheduling instance; receiving a reduced set of tasks selected from the initial set of tasks; identifying a first feature vector for each task in the initial set of tasks; identifying a second feature vector for each task in the reduced set of tasks; for each first feature vector, computing an aggregate similarity score between the first feature vector and all of the second feature vectors; and selecting the top C tasks in the initial set of tasks in dependence on the computed aggregate similarity scores, to form the pool P of C candidate tasks.

The preceding fourth embodiments provide a technical feature of generating the pool P of C candidate tasks in a manner that generates a reduced set of tasks from the initial scheduling instance and then selects the tasks in the pool based on similarity of features of tasks in the reduced set of tasks. Thus, the generated pool of tasks includes fewer tasks, but most significant tasks, which enables the output scenarios of tasks to be generated more efficiently with reduced computation time.

A work process is characterized as a set of T tasks to be performed, wherein each task of the T tasks is a job to be performed and constraints associated with the job. Thus, a task includes both the job and the constraints associated with the job. A job is defined as a function or one or more steps to be performed.

The work process is performed in accordance with a scheduling instance of a schedule, and it is desirable to optimize the scheduling instance to improve the work process in accordance with key performance indicators (KPIs).

The work process may be, inter alia: a physical process, a computation process (e.g., a cloud computing process, an artificial intelligence application, a Monte Carlo process, etc.), a medical process, etc. Examples of a physical process include, inter alia: a manufacturing process, a chemical process, an energy transformation process, a resource extraction process (e.g., drilling for oil or natural gas), a product purification process (e.g., removal of impurities from a substance, a waste disposal process, etc.

The key performance indicators (KPIs) may include any of, inter alia: total time duration for completion of the work process; total time expended during performance of the work process; amount of each resource, or specifically specified resources, used for implementing the work process; amount of energy expended for performing the work process; quality level (e.g., accuracy, tolerances) of the final result (e.g., a manufactured product, a computed result; degree of success of a medical procedure) from completion of the work process; environmental quality (e.g., contaminants, temperature, humidity, air quality, etc.).

An existing approach for improving the scheduling instance is via manual process of specifying of a set of scenarios that is tried out for arriving at an improved scheduling instance, wherein a scenario is a set of tasks. Unfortunately, such a manual process is labor intensive and requires expenditure of many expensive human hours.

Another existing approach for improving the scheduling instance is brute force in which all of potential scenarios of the T tasks are tried out to pick the scenarios that give the most benefit or have the most relevance according to criteria, which results in combinatorial explosion and is intractable even for small scheduling instances/scenario sizes.

Another existing approach for improving the scheduling instance is use of Monte Carlo techniques, which suffer a curse of dimensionality and ignore the combinatorial structure of the scheduling problem.

The scheduling problem to be solved by embodiments of the present invention is characterized by a pool P of C tasks from which k scenarios are determined with each scenario encompassing b tasks. The C tasks are candidate tasks, some of which are to be modified for use in the scheduling for the work process.

Consider an example of a scheduling problem with 1000 tasks (T=1000). To generate 20 scenarios (k=20) from a pool P of 20 tasks (C=20) with scenario size b of 2 (i.e., 2 tasks per scenario), the brute force approach would explore ₁₀₀₀C₂ unique scenarios (i.e., 499,500 unique scenarios drawn from 1000 tasks taking 2 tasks at a time), which is clearly infeasible.

In contrast, embodiments of the present invention have a runtime upper limit of k×b×C scenarios, namely 20×2×20 scenarios (i.e., 800 scenarios) in this example, which provides a significant speedup gain of 624.

Embodiments of the present invention utilize a method that includes a first step of determining a candidate pool P of C tasks and a second step of generating a combinatorial scenario on the candidate pool P.

The first step of determining a candidate pool P of C tasks may be implemented via an embodiment that uses a critical path of tasks and a cluster analysis (described infra) or via an embodiment that uses a similarity-based approach (described infra).

The second step of generating a combinatorial scenario uses a modified greedy approach that keeps track of the top k scenarios while iteratively increasing the scenario sizes until the final iteration in which scenario size b is operative. The runtime of this algorithm is linear in the size C of the candidate pool P (keeping the scenario size fixed), which results in a significantly faster approach to the current manual/brute force strategies (which require exponentially many optimizations).

The input to a method in accordance with embodiments of the present invention includes: (i) an initial scheduling instance I of a large-scale scheduling problem for tasks that have constraints (time constraints, resource constraints, precedence constraints, etc.), (ii) the scenario size b (i.e., number of tasks per scenario), (iii) the coverage parameter k (the number of scenarios), and (iv) a black-box optimizer β for optimizing or improving the initial scheduling instance I with respect to key performance indicators (KPIs).

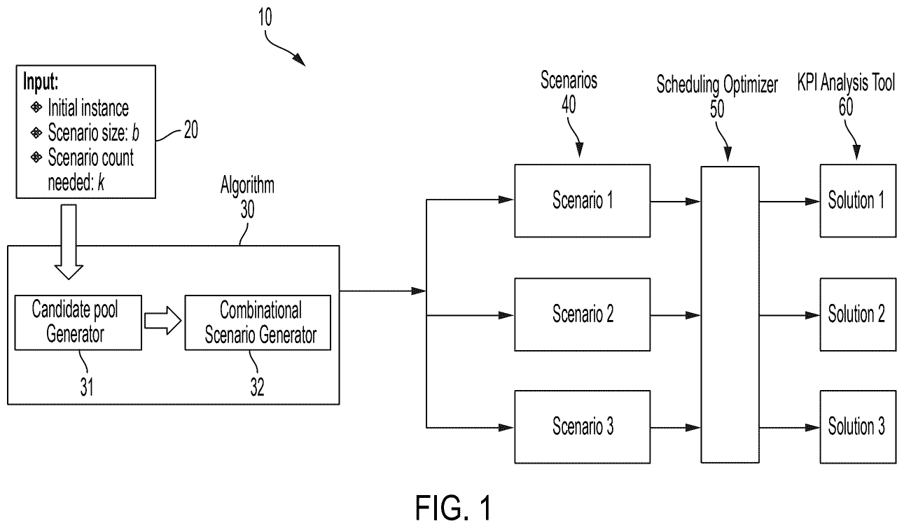

FIG. 1 depicts a system 10 for scheduling a work process, in accordance with embodiments of the present invention.

The system 10 includes an algorithm 30 which receives input 20, k scenarios 40 (k=3 in FIG. 1) outputted by execution of the algorithm 30, a scheduling optimizer 50, and a KPI analysis tool 60.

The input 20 to the algorithm 30 includes: an initial scheduling instance I of a large-scale scheduling problem for tasks with constraints (resource constraints, precedence constraints, time-window constraints, the scenario size b and the coverage parameter k (number of scenarios), and a black-box optimizer β for optimizing or improving the initial scheduling instance I

The algorithm 30 includes use of (i) a candidate pool generator 31 for performing the first step of determining a candidate pool P of C tasks and (ii) a combinatorial scenario generator 32 for performing the second step of generating a combinatorial scenario on the candidate pool P, wherein output from the candidate pool generator 31 serves an input to the combinatorial scenario generator 32 as shown.

Output from the combinatorial scenario generator 32 includes the k scenarios 40 (k=3 in FIG. 1) of Scenarios 1, Scenario 2, and Scenario 3, which feed into the scheduling optimizer 50.

The scheduling optimizer 50 computes respective k scheduling instances denoted as Solution 1, Solution 2 and Solution 3, with respective impacts on key performance indicators (KPIs) as determined by the KPI analysis tool 60.

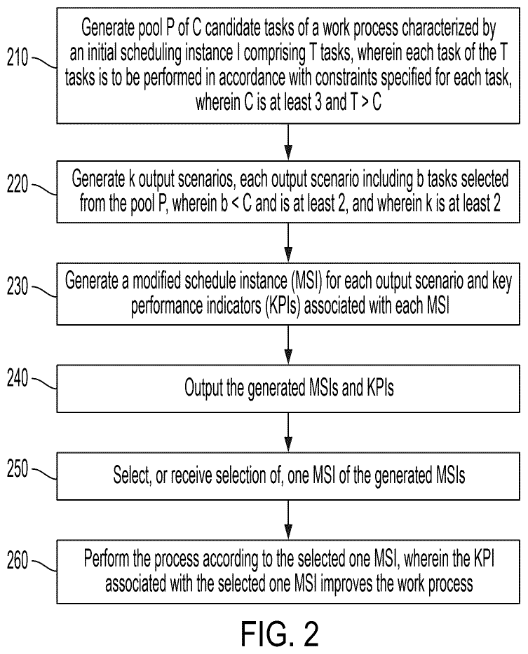

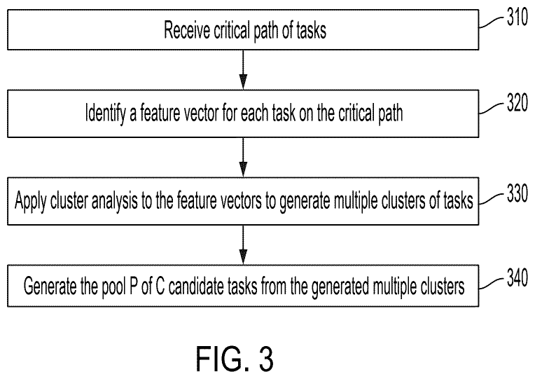

The first step of determining a candidate pool of P tasks may be implemented via the process of FIG. 2 or FIG. 3 as described infra.

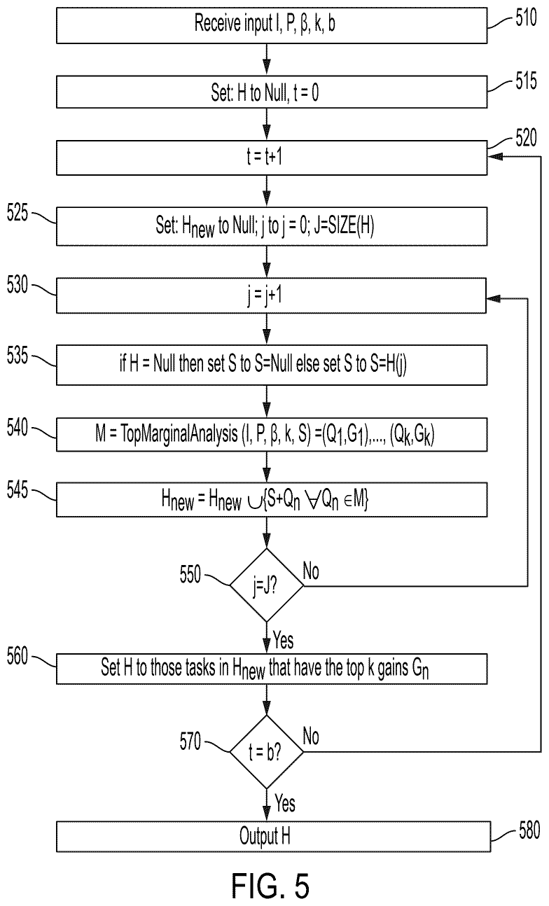

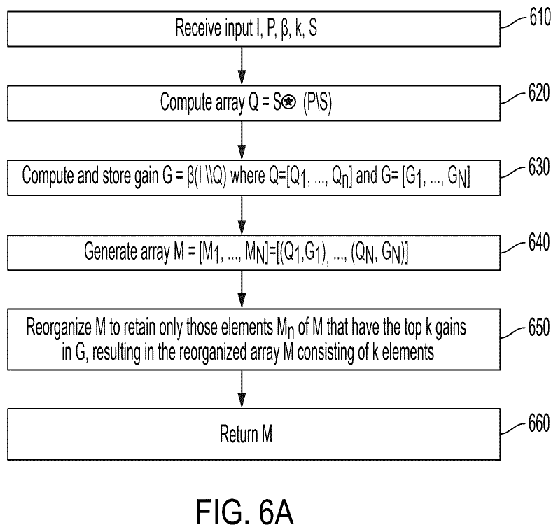

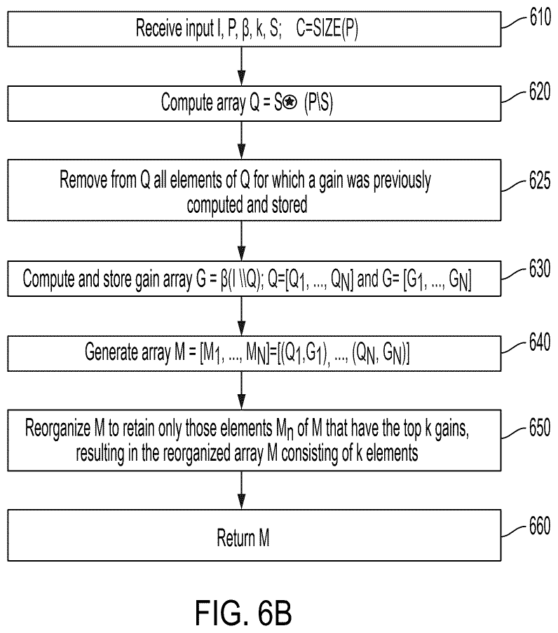

The second step of generating a combinatorial scenario on the candidate pool P may be implemented via (i) combined use of Algorithm 1 in Table 1 and Algorithm 2 in Table 2 or (ii) the process of FIGS. 5, 6A, and 6B as described infra.

Algorithm 1 in Table 1 is a TopMarginalAnalysis algorithm and Algorithm 2 in Table 2 is a modified greedy algorithm. Algorithm 2 invokes Algorithm 1 within an outer iteration loop of Algorithm 2 as will be discussed infra.

TABLE 1
Algorithm 1: TopMarginalAnalysis Algorithm

Input: initial scheduling instance I = (T, P), blackbox optimizer β, candidate pool
C, coverage k (number of scenarios)
Output: A set of k tasks M = {(sᵢ, tₛᵢ)}_{i∈[k]}, sᵢ ∈ C, ∀i ∈ [k]

| | |
|---|---|
| 1: | Initialization: Initialize M ← Null |
| 2: | for s ∈ [C] do |
| 3: | Compute the modified scheduling instance: Iₛ = I \ {s} |
| 4: | tₛ ← β(Iₛ) |
| 5: | M = M + (s, tₛ) |
| 6: | end for |
| 7: | Set M ← TOPK(M, k) |
| 8: | return M |

TABLE 2
Algorithm 2: Modified Greedy Algorithm

Input: initial scheduling instance I = (T, P), blackbox optimizer β, candidate pool
C, budget b (scenario size), coverage k (number of scenarios)
Output: A set of k scenarios H = {Sᵢ}_{i∈[k]}, where | Sᵢ | ≤ b, ∀i ∈ [k]

| 1: | Initialization: Initialize H ← Null | |
|---|---|---|
| 2: | for t ∈ [b] do | |
| 3: | H_{new} ← Null | » Initialize updated scenario set to empty |
| 4: | for S = (S, tₛ) ∈ H do | » For each scenario from the previous iteration |

| | |
|---|---|
| 5: | Compute the modified scheduling instance: I \ S |
| 6: | M ← TopMarginalAnalysis (I \ S, β, C \ S, k) » Perform marginal |

analysis on the modified scheduling instance I \ S, using the candidate pool C \ S
and pick the top k scenarios

| | |
|---|---|
| 7: | H_{new} ← H_{new} ∪ {(S + s,tₛ) : ∀ s,tₛ ∈ M} |
| 8: | end for |
| 9: | Set H ← TOPK(H_{new}, k) |
| 10: | end for |
| 11: | return H |

Algorithm 1 requires input of, inter alia: initial scheduling instance I for T tasks, blackbox optimizer β, a candidate pool of C tasks, and coverage k (number of scenarios).

The output from Algorithm 1 is a set of k tasks in an array M={(sᵢ, tₛᵢ)}_{i∈[k]}, sᵢ∈C, ∀i∈[k], where si denotes one or more tasks and tₛᵢ denotes a gain associated with modification of the initial scheduling instance I by modification of the one or more tasks si (e.g., by the one or more tasks si being deleted from the initial scheduling instance I).

In line 1, M is initialized to Null.

Definitionally, a variable or an array is Null if the variable or array has been declared but does not hold any data.

Lines 2-6 define a loop of iterations over the tasks in the pool with an iteration index s∈[C], with lines 2 and 6 delineating the beginning and end, respectively, of each iteration of the loop.

In line 3, a modified scheduling instance Iₛ is computed via Iₛ=I\{s}. Although the modified scheduling instance Iₛ is depicted as a deletion of the task s from the initial scheduling instance I, any other modification of the task s may alternatively be used as will be described infra.

In line 4, the blackbox optimizer β is applied to the modified instance Iₛ to determine a gain tₛ which specifies an improvement in one or more KPIs.

In line 5, M is updated via M=M+(s, tₛ)

In line 7, M is reorganized, via execution of function TOPK(M,k) to retain only those elements in M whose tasks have the top k gains tₛ, resulting in the reorganized array M consisting of k elements.

In line 9, M is returned to the invoking program of Algorithm 2 which invokes Algorithm 1 in line 6 of Algorithm 2.

Algorithm 2 requires input of, inter alia: initial scheduling instance I for T tasks, blackbox optimizer β, a candidate pool of C tasks outputted from Step 1, budget b (number of tasks per scenario), and coverage k (number of scenarios).

The output from Algorithm 2 is an array H of k scenarios, wherein H={Sᵢ}_{i∈[k]}, where |Sᵢ|≤b ∀i∈[k].

In line 1, H is initialized to Null.

Lines 2-10 define an outer loop of in which the outer loop index t is from t=1 to t=b, wherein b is the number of tasks in a scenario, with lines 2 and 10 delineating the beginning and end, respectively, of each iteration of the outer loop.

In line 3, an array H_{new} is initialized to Null.

Lines 4-8 define an inner loop of in which the inner loop index S is selected in each iteration according to S=(S, tₛ)∈H, with lines 4 and 8 delineating the beginning and end, respectively, of each iteration of the inner loop. S denotes one or more tasks.

In line 5, the modified scheduling instance I\S is computed. Although the modified scheduling instance I\S is described as a deletion of the one or more tasks S from the initial scheduling instance I, any other modification of the one or more tasks S may alternatively be used for computing the modified scheduling instance as will be described infra.

In line 6, the TopMarginalAnalysis function in Algorithm 1 is invoked, wherein in Algorithm 1, a marginal analysis is performed on the modified scheduling instance I\S, using the candidate pool, after which the top k tasks having the largest gains are selected via execution of function TOPK(M, k) in line 7 of Algorithm 1.

In line 7, H_{new} is updated according to H_{new}←H_{new}∪{(S+s,tₛ): ∀ s,tₛ∈M} for task s with associated gain tₛ.

In line 9, which is within the outer loop and outside of the inner loop, the array H is returned by function TOPK(H_{new},k) which selects the scenarios having the top k gains tₛ.

In line 11, H is returned (i.e., outputted).

FIG. 2 is a flow chart of an embodiment of a method for optimizing a scheduling instance for a work process and performing the work process in accordance with the optimized scheduling instance, in accordance with embodiments of the present invention.

The work process may be, inter alia: a physical process, a computation process (e.g., a cloud computing process, an artificial intelligence application, a Monte Carlo process, etc.), a medical process, etc. Examples of a physical process include, inter alia: a manufacturing process, a chemical process, an energy transformation process, a resource extraction process (e.g., drilling for oil or natural gas), a product purification process (e.g., removal of impurities from a substance, a waste disposal process, etc.

The flow chart of FIG. 3 includes steps 210-260.

Step 210 generates a pool P of C candidate tasks of a work process characterized by an initial scheduling instance I comprising T tasks, wherein each task of the T tasks is a job to be performed and constraints associated with the job, and wherein C is at least 3 and T>C. In embodiments, T may have values in ranges of, inter alia: T≥3, T≥5, T≥10, 10≤T≤100, 100≤T≤1000, 1000≤T≤10000, T≥10000.

For each job of a task, the constraints may include, inter alia, maximum time for executing the job, specific times when the job is permitted to be executed and/or specific times when the job is not permitted to be executed, dependencies on other tasks, constraints on resources (material, machines, tools, maximum storage for storing data, etc.) used, tolerances on outputs from execution of the job, constraints on environmental effects from executing the job).

Step 220 generates k output scenarios, wherein each output scenario includes b tasks selected from the pool P, wherein b<C and is at least 2, and wherein k is at least 2.

Step 230 generates both a modified scheduling instance (MSI) for each output scenario and key performance indicators (KPIs) associated with each MSI.

The key performance indicators (KPIs) may include any of, inter alia: total time duration for completion of the work process; total time expended during performance of the work process; amount of each resource, or specifically specified resources, used for implementing the work process; amount of energy expended for performing the work process; quality level (e.g., accuracy, tolerances) of the final result (e.g., a manufactured product, a computed result; degree of success of a medical procedure) from completion of the work process; environmental quality (e.g., contaminants, temperature, humidity, air quality, etc.).

The key performance indicators (KPIs) may be specific to the type of work process.

For example, the KPIs for a chemical process may include, inter alia: yield percentage of the theoretical amount of product obtained from the process), throughput (amount of product produced over a specified time duration), selectivity (ratio of the desired product formed to the total products formed), energy consumption (amount of energy used per unit of product produced), etc.

For example, the KPIs for a waste disposal process may include, inter alia: collection rate (percentage of waste collected compared to the total waste generated), collection time (average time taken to collect waste from different locations), recycling rate (percentage of collected waste that is recycled), landfill usage (percent of waste sent to landfills), etc.

Step 240 outputs the generated MSIs and KPIs (e.g., to a data storage to another computer/computer system such as, inter alia, a computer/computer system of a user).

Step 250 selects or receives a selection of: one MSI of the generated MSIs. In one embodiment, the one MSI that is selected is the MSI having the highest KPI or KPIs.

Step 260 performs the work process in accordance with the selected one MSI, wherein the KPI associated with the selected one MSI improves the work process.

FIG. 3 is a flow chart describing a first embodiment of a process for generating the pool P of C candidate tasks, in accordance with embodiments of the present invention.

The flow chart of FIG. 3, which is an embodiment for implementing step 210 of FIG. 2, includes steps 310-340.

Step 310 receives a critical path of tasks.

Step 320 identifies a feature vector for each task on the critical path. A feature vector is a vector of features of a task, wherein such features may include, inter alia, constraints for the task as described supra and infra.

Step 330 applies cluster analysis to the feature vectors to generate multiple clusters of tasks.

Cluster analysis is used to group a set of the feature vectors in such a way that feature vectors in the same cluster are more similar to each other than to feature vectors in other clusters. Cluster properties that distinguish different clusters may include, inter alia: degree of similarity of feature vectors in the same cluster, degree to which the feature vectors in one cluster differ from the feature vectors in the other clusters, cluster size (i.e., number of feature vectors in the cluster), cluster shape (e.g., spherical, elongated).

Step 340 generates the pool P of C candidate tasks from the generated multiple clusters.

In one embodiment, the pool P of C candidate tasks may be selected as the tasks in one or more clusters selected from the multiple clusters based on one or more of the preceding cluster properties which, in one embodiment, may be weighted relative to each other.

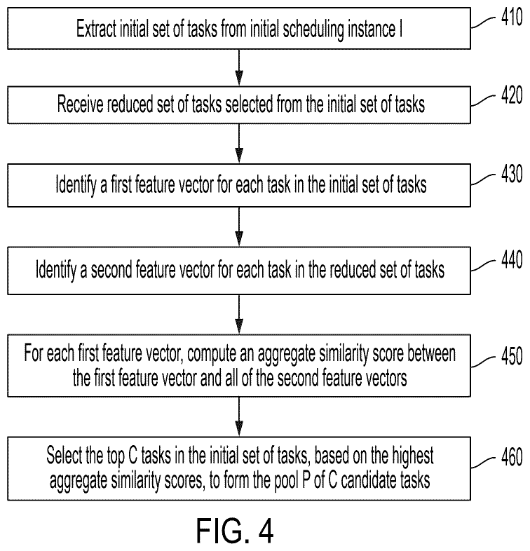

FIG. 4 is a flow chart describing a second embodiment of a process for generating the pool P of C candidate tasks, in accordance with embodiments of the present invention.

The flow chart of FIG. 4, which is an embodiment for implementing step 210 of FIG. 2, includes steps 410-460.

Step 410 extracts an initial set of tasks from the initial scheduling instance I.

Step 420 receives a reduced set of tasks selected from the initial set of tasks.

Step 430 identifies a first feature vector for each task in the initial set of tasks.

Step 440 identifies a second feature vector for each task in the reduced set of tasks.

Step 450 computes, for each first feature vector, an aggregate similarity score between the first feature vector and all of the second feature vectors.

Step 460 selects the top C tasks in the initial set of tasks, based on the highest aggregate similarity scores, to form the pool P of C candidate tasks.

FIG. 5 is a flow chart for generating k output scenarios for the work process, in accordance with embodiments of the present invention.

The flow chart of FIG. 5, which includes steps 510-580, is an embodiment for implementing step 220 of FIG. 2 and is a version of the modified greedy algorithm presented in Table 2 discussed supra.

Each output scenario of the k output scenarios includes b tasks. Each task of the b tasks is selected from the pool P of C candidate tasks, wherein b<C, b is at least 2, and k is at least 2

Step 510 receives inputs of: the initial scheduling instance I, the pool P of C candidate tasks, blackbox optimizer β, number of output scenarios k, scenario size b (number of tasks per scenario), and α which is an integer in a range of 1 to b−1.

The blackbox optimizer β optimizes or improves a scheduling instance with respect to key performance indicators (KPIs). In one embodiment, the details of how the blackbox optimizer β optimizes or improves the scheduling instance are specific to the work process and the tasks included in the work process.

Step 515 sets array H to Null and an outer loop index t to t=0.

Steps 520-570 define an outer loop in which the outer loop index t is from t=1 to t=b.

Step 520 increments t by 1 which confirms that t=1 for the first iteration of the outer loop.

Step 525 sets: array H_{new} to Null; inner iteration index j to j=0; and J to J=SIZE(H)

Definitionally, SIZE(H) is 1 if H is Null and SIZE(H) is the total number of elements in H if H is not Null. For example, if H consists of the 3 elements of (t₁, t₂), (t₁, t₃), (t₂, t₃), then SIZE(H) is 3.

Steps 530-550 define an inner loop in which the inner loop index j is from j=1 to j=J), wherein J is at least 1.

Step 530 increments j by 1.

Step 535 performs: if H=Null then S is set to S=Null else S is set to S=H(j) (j=1, . . . , J).

For example, if H=(t₁, t₂), (t₁, t₃), (t₂, t₃), then H (1)=(t₁, t₂), H (2)=(t₁, t₃), and H (3)=(t₂, t₃).

Step 540 performs TopMarginalAnalysis (I, P, β, k, S) which returns array M=[(Q₁,G₁), . . . , (Qₖ,Gₖ)], wherein M has k elements with each element of the k elements being of the form (Qₙ, Gₙ) (n=1, . . . , k), wherein Qₙ is a task or a task permutation/combination, and wherein Gₙ is a gain resulting from modifying I by a modification of Qₙ.

Modifying I by a modification of Qₙ is denoted as a modified scheduling instance III Qₙ, wherein the modification operator \\ denotes a modification of Qₙ which in turn modifies I.

In one embodiment the modification operator \\ is the deletion operator \, so that the modified scheduling instance I\Qₙ denotes that Qₙ is deleted from I.

Generally, the modification of Qₙ may be, inter alia, a deletion of the task(s) Qₙ, a modification of resources used by the task(s) Qₙ, a modification of the scope of the task(s) Qₙ (e.g., reducing or eliminating one or more functionalities of the task(s) Qₙ), modifying any of the constraints on the job(s) associated with the task(s) Qₙ, etc.

The constraints on the job(s) associated with the task(s) Qₙ may include, inter alia, maximum time for executing the job, specific times when the job is permitted to be executed and/or specific times when the job is not permitted to be executed, dependencies on other tasks, constraint on resources (material, machines, tools, data storage, etc.), tolerances on outputs from execution of the job, constraints on environmental effects (e.g., temperature, humidity, air quality, etc.) from executing the job, etc.

The gain Gₙ is an improvement provided by the modified scheduling instance I\\Qₙ, with respect to the initial scheduling instance I as measured by one or more key performance indicators (KPIs).

The key performance indicators (KPIs) may include any of, inter alia: total time duration for completion of the work process; total time expended during performance of the work process; amount of each resource, or specifically specified resources, used for implementing the work process; amount of energy expended for performing the work process; quality level (e.g., accuracy, tolerances) of the final result (e.g., a manufactured product, a computed result; degree of success of a medical procedure) from completion of the work process; environmental quality (e.g., contaminants, temperature, humidity, air quality, etc.).

A first and second version of TopMarginalAnalysis, which is invoked in step 540, is presented in FIG. 6A and FIG. 6B, respectively, discussed infra.

Step 545 updates H_{new}=H_{new}∪{S+Qₙ∀Qₙ∈M}.

Step 550 determines whether j=J. If so (Yes branch from step 550) then step 560 is next performed. If not (No branch from step 550) then the method branches back to step 530 to perform the next iteration of the inner loop.

Step 560 sets H to those tasks of H_{new} that have the top k gains Gₙ. If there are k′ tasks in H_{new} having the top k gains, wherein k′>k due to multiple tasks in H_{new} having a same gain, then the k′ tasks may be reduced to k tasks by randomly selecting tasks from tasks in H_{new} having the same gain.

Step 570 determines whether t=b. If so (Yes branch from step 570) then step 580 is next performed. If not (No branch from step 520) then the method branches back to step 530 to perform the next iteration of the outer loop.

Step 580 outputs H. The outputted H is the k output scenarios generated in step 220 of FIG. 2.

FIG. 6A is a flow chart of a first version of a TopMarginalAnalysis algorithm, in accordance with embodiments of the present invention.

The TopMarginalAnalysis function in FIG. 6A, which includes steps 610-660, may be invoked by step 540 of FIG. 5 and is a version of the TopMarginalAnalysis algorithm presented in Table 1 discussed supra.

Step 610 receives inputs I, P, β, k, S.

Step 620 computes the array Q via Q=S\textcircled{★}(P\S). The operator \textcircled{★} is defined as follows: r\textcircled{★}(t₁, t₂, . . . , t_{N})=(r, t₁), (r, t₂), . . . (r, t_{N}) subject to N≥1, where r is Null or a set of one or more elements and (t₁, t₂, . . . t_{N}) is a set of the N elements t₁, t₂, . . . , and t_{N}. For example, if r=(r₁, r₂) then (r₁, r₂)\textcircled{★}(t₁, t₂)=(r₁, r₂, t₁), (r₁, r₂, t₂).

For example, if S=t₁ and P\S=t₂, t₃, t₄, then Q=(t₁,t₂), (t₁,t₃), (t₁,t₄).

Step 630 computes and stores gain array G via G=β(I\\Q) wherein Q=[Q₁, . . . , Q_{N}] and G=[G₁, . . . , G_{N}].

Step 640 generates array M=[M₁, . . . , M_{N}]=[(Q₁,G₁), . . . , (Q_{N},G_{N})];

Step 650 reorganizes M to retain only those elements Mₙ of M that have the top k gains in G, resulting in the reorganized array M consisting of k elements: M₁, . . . , Mₖ. If there are k′ tasks in M having the top k gains, wherein k′>k due to multiple tasks in M having a same gain, then the k′ tasks may be reduced to k tasks by randomly selecting tasks from tasks in M having the same gain.

Step 660 returns M to the process that invoked the TopMarginalAnalysis function. The TopMarginalAnalysis function was invoked from step 540 of the modified greedy process of FIG. 5.

FIG. 6B is a flow chart of a second version of a TopMarginalAnalysis algorithm, in accordance with embodiments of the present invention.

The TopMarginalAnalysis function in FIG. 6B differs from the TopMarginalAnalysis function in FIG. 6A by including an extra step 625 between steps 620 and 630.

Step 625 removes from Q all elements of Q for which a gain was previously computed and stored in step 630 from an earlier invocation of TopMarginalAnalysis, which improves computational efficiency by removing redundant elements of Q.

The following example illustrates the methodology of FIGS. 5, 6A, and 6B.

In the example, the initial scheduling instance I has 10 tasks t₁, . . . , t₁₀; the pool P has 4 tasks (C=4) t₁, t₂, t₃, t₄: k=2; b=2; α=1; the modification operator \\ is the deletion operator \; and the first version of TopMarginalAnalysis (FIG. 6A) is used.

In the example, the gain resulting from use of the blackbox optimizer β is a reduction in turnaround time, namely: an original turnaround time based on the initial scheduling instance minus a reduced turnaround time based on the modified scheduling instance.

In the first outer iteration, (t=1), H is Null and S is Null. Thus, in execution of TopMarginl Analysis, Q=S\textcircled{★}(P\S)=P=t₁, t₂, t₃, t₄ and assume G=β(I\\Q)=2, 3, 1.5, 1.

Thus, M initially is (t₁, 2), (t₂,3), (t₃,1.5), (t₄,1), which is reorganized to the top k (i.e., the top 2) Gₙ values to M=(t₁, 2), (t₂,3). Thus, H_{new}=(t₁, 2), (t₂,3) since S is Null, and H=t₁, t₂ by extracting the tasks t₁ and t₂ from H_{new}.

In the second outer iteration, initially H=t₁, t₂.

In the first inner iteration within the second outer iteration, execution of TopMarginalAnalysis performs S=H(1)=t₁, and Q=S\textcircled{★}(P\S)=t₁\textcircled{★}(t₁, t₂, t₃, t₄\t₁)=t₁\textcircled{★}(t₂, t₃, t₄)=(t₁, t₂), (t₁, t₃), (t₁, t₄). Assume G=β(I\\Q)=0.5, 0.75, 0.8, so that M is initially determined and then reorganized to the top 2 gains to M={(t₁, t₃), 0.75}, {(t₁, t₄), 0.8}.

In the second inner iteration within the second outer iteration, execution of TopMarginalAnalysis performs S=H (2)=t₂, and Q=S\textcircled{★}(P\S)=t₂\textcircled{★}(t₁, t₂, t₃, t₄\t₂)=t₂\textcircled{★}(t₁, t₃, t₄)=(t₂, t₁), (t₂, t₃), (t₂, t₄). Assume G=β(I\Q)=0.5, 1, 0.8, so that M is initially determined and then reorganized to the top 2 gains to M={(t₂, t₃), 1}, {(t₂, t₄), 0.8}. At the end of the second inner iteration, H_{new}={(t₁, t₃), 0.75}, {(t₁, t₄), 0.8}, {(t₂, t₃), 1}, {(t₂, t₄), 0.8}.

At the end of the second outer iteration, the final output H from step 580 is the 2 task components in H_{new} having the top 2 gains which are (t₂, t₃), (t₂, t₄), wherein (t₂, t₄) having a gain of 0.8 is picked randomly over (t₁, t₄) having a gain of 0.8.

The computation time for performing the method depends primarily on the number of executions of the blackbox optimizer β. For this example, there are 10 executions of the blackbox optimizer β.

Since the first and second inner iterations use redundant Q elements of (t₁, t₂) and (t₂, t₁), respectively, the computational efficiency could be improved by using the second version of TopMarginalAnalysis (FIG. 6B) in which step 625 avoids use of the redundant element (t₂, t₁) of Q, resulting in 9 executions of the blackbox optimizer β.

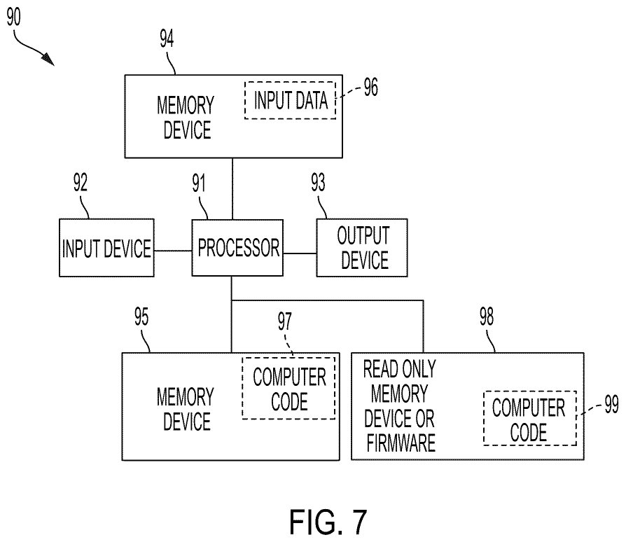

FIG. 7 illustrates a computer system 90, in accordance with embodiments of the present invention.

The computer system 90 includes a processor 91, an input device 92 coupled to the processor 91, an output device 93 coupled to the processor 91, and memory devices 94 and 95 each coupled to the processor 91. The processor 91 represents one or more processors and may denote a single processor or a plurality of processors. The input device 92 may be, inter alia, a keyboard, a mouse, a camera, a touchscreen, etc., or a combination thereof. The output device 93 may be, inter alia, a printer, a plotter, a computer screen, a magnetic tape, a removable hard disk, a floppy disk, etc., or a combination thereof. The memory devices 94 and 95 may each be, inter alia, a hard disk, a floppy disk, a magnetic tape, an optical storage such as a compact disc (CD) or a digital video disc (DVD), a dynamic random access memory (DRAM), a read-only memory (ROM), etc., or a combination thereof. The memory device 95 includes a computer code 97. The computer code 97 includes algorithms for executing embodiments of the present invention. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices such as read only memory device 96) may include algorithms and may be used as a computer usable medium (or a computer readable medium or a program storage device) having a computer readable program code embodied therein and/or having other data stored therein, wherein the computer readable program code includes the computer code 97. Generally, a computer program product (or, alternatively, an article of manufacture) of the computer system 90 may include the computer usable medium (or the program storage device).

In some embodiments, rather than being stored and accessed from a hard drive, optical disc or other writeable, rewriteable, or removable hardware memory device 95, stored computer program code 99 (e.g., including algorithms) may be stored on a static, nonremovable, read-only storage medium such as a Read-Only Memory (ROM) device 98, or may be accessed by processor 91 directly from such a static, nonremovable, read-only medium 98. Similarly, in some embodiments, stored computer program code 99 may be stored as computer-readable firmware, or may be accessed by processor 91 directly from such firmware, rather than from a more dynamic or removable hardware data-storage device 95, such as a hard drive or optical disc.

Still yet, any of the components of the present invention could be created, integrated, hosted, maintained, deployed, managed, serviced, etc. by a service supplier who offers to improve software technology associated with cross-referencing metrics associated with plug-in components, generating software code modules, and enabling operational functionality of target cloud components. Thus, the present invention discloses a process for deploying, creating, integrating, hosting, maintaining, and/or integrating computing infrastructure, including integrating computer-readable code into the computer system 90, wherein the code in combination with the computer system 90 is capable of performing a method for enabling a process for improving software technology associated with cross-referencing metrics associated with plug-in components, generating software code modules, and enabling operational functionality of target cloud components. In another embodiment, the invention provides a business method that performs the process steps of the invention on a subscription, advertising, and/or fee basis. That is, a service supplier, such as a Solution Integrator, could offer to enable a process for improving software technology associated with cross-referencing metrics associated with plug-in components, generating software code modules, and enabling operational functionality of target cloud components. In this case, the service supplier can create, maintain, support, etc. a computer infrastructure that performs the process steps of the invention for one or more customers. In return, the service supplier can receive payment from the customer(s) under a subscription and/or fee agreement and/or the service supplier can receive payment from the sale of advertising content to one or more third parties.

While FIG. 7 shows the computer system 90 as a particular configuration of hardware and software, any configuration of hardware and software, as would be known to a person of ordinary skill in the art, may be utilized for the purposes stated supra in conjunction with the particular computer system 90 of FIG. 7. For example, the memory devices 94 and 95 may be portions of a single memory device rather than separate memory devices.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

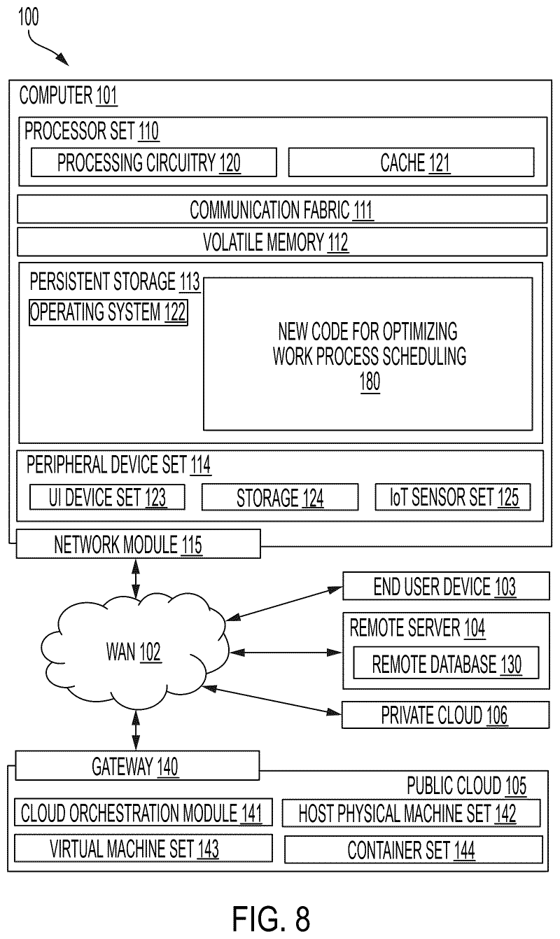

FIG. 8 depicts a computing environment 100 which contains an example of an environment for the execution of at least some of the computer code involved in performing the inventive methods, in accordance with embodiments of the present invention. Such computer code includes new code for optimizing work process scheduling 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for optimizing a scheduling instance for a work process and performing the work process in accordance with the optimized scheduling instance, said method comprising:
generating, by one or more processors of a computer system, a pool P of C candidate tasks of a work process characterized by an initial scheduling instance I comprising T tasks, wherein each task of the T tasks is a job to be performed and constrains associated with the job, and wherein C is at least 3 and T>C;
generating, by the one or more processors, k output scenarios, wherein each output scenario includes b tasks, each task of the b tasks selected from the pool P, wherein b<C, b is at least 2, and k is at least 2;
generating, by the one or more processors, both a modified schedule instance (MSI) for each output scenario and key performance indicators (KPIs) associated with each MSI;
outputting, by the one or more processors, the generated MSIs and KPIs;
selecting or receiving a selection of, by the one or more processors, one MSI of the generated MSIs; and
performing by the one or more processors, the work process in accordance with the selected one MSI, wherein the KPIs associated with the selected one MSI improves the work process.

2. The method of claim 1, wherein said generating k output scenarios comprises:
receiving input of I, P, β, k, and b, wherein β is a blackbox optimizer;
setting an array H to Null;
performing an outer iterative process over outer iterations t from t=1 to t=b, wherein the outer iterative process comprises: determining an array H_{new} of subsets of tasks in P and a gain associated with each subset of tasks in H_{new}, wherein said determining the array H_{new} is performed in dependence on I, β, k, and H; and setting H to be an array of k elements of H_{new} that have the highest gains; and
after said performing an outer iterative process, outputting H wherein the outputted H is the k output scenarios.

3. The method of claim 2, wherein said determining the array H_{new} comprises:
setting H_{new} to Null;
performing an inner iterative process over inner iterations j from j=1 to j=J, wherein J=SIZE(H), and wherein the inner iterative process comprises for iteration j (j=1, . . . , J):
if H is Null then setting an array S to Null else setting S to S=H(j);
performing TopMarginalAnalysis (I, P, β, k, S) which outputs an array M having k elements structured as M₁, . . . , Mₖ, wherein each element Mₙ of M is one or more tasks Qₙ in the pool P and an associated gain Gₙ (n=1, . . . , k); and
updating H_{new} according to H_{new}=H_{new}∪{S+Qₙ∀Qₙ∈M}.

4. The method of claim 3, wherein said performing TopMarginalAnalysis (I, P, β, k, S) comprises:
receiving inputs I, P, β, k, and S;
computing array Q via Q=S\textcircled{★}(P\S);
computing and storing gain array G=β(I\\Q); Q=[Q₁, . . . , Q_{N}] and G=[G₁, . . . , G_{N}];
generating array M=[M₁, . . . , M_{N})]=[(Q₁,G₁), . . . , (Q_{N},G_{N})];
reorganizing M to retain only those elements Mₙ of M that have the top k gains in G, resulting in the reorganized array M consisting of k elements; and
returning M.

5. The method of claim 4, wherein said performing TopMarginalAnalysis (I, P, β, k, S) further comprises:
after said computing array Q and before said computing and storing gain array G, removing from Q each element of Q that was previously computed and stored.

6. The method of claim 1, wherein said generating the pool P of C candidate tasks comprises:
receiving a critical path of tasks;
identifying a feature vector for each task on the critical path;
applying cluster analysis to the feature vectors to generate multiple clusters of tasks; and
generating the pool P of C candidate tasks from the generated multiple clusters.

7. The method of claim 1, wherein said generating the pool P of C candidate tasks comprises:
extracting an initial set of tasks from the initial scheduling instance;
receiving a reduced set of tasks selected from the initial set of tasks;
identifying a first feature vector for each task in the initial set of tasks;
identifying a second feature vector for each task in the reduced set of tasks;
for each first feature vector, computing an aggregate similarity score between the first feature vector and all of the second feature vectors; and
selecting the top C tasks in the initial set of tasks in dependence on the computed aggregate similarity scores, to form the pool P of C candidate tasks.

8. A computer program product, comprising one or more computer readable hardware storage devices having computer readable program code stored therein, said program code containing instructions executable by one or more processors of a computer system to implement a method for determining keywords from raw data, said method comprising:
generating, by the one or more processors, a pool P of C candidate tasks of a work process characterized by an initial scheduling instance I comprising T tasks, wherein each task of the T tasks is a job to be performed and constrains associated with the job, and wherein C is at least 3 and T>C;
generating, by the one or more processors, k output scenarios, wherein each output scenario includes b tasks selected from the pool P, wherein b<C, b is at least 2, and k is at least 2;
generating, by the one or more processors, both a modified schedule instance (MSI) for each output scenario and key performance indicators (KPIs) associated with each MSI;
outputting, by the one or more processors, the generated MSIs and KPIs;
selecting or receiving a selection of, by the one or more processors, one MSI of the generated MSIs; and
performing by the one or more processors, the work process in accordance with the selected one MSI, wherein the KPIs associated with the selected one MSI improves the work process.

9. The computer program product of claim 8, wherein said generating k output scenarios comprises:
receiving input of I, P, β, k, and b, wherein β is a blackbox optimizer;
setting an array H to Null;
performing an outer iterative process over outer iterations t from t=1 to t=b, wherein the outer iterative process comprises: determining an array H_{new} of subsets of tasks in P and a gain associated with each subset of tasks in H_{new}, wherein said determining the array H_{new} is performed in dependence on I, β, k, and H; and setting H to be an array of k elements of H_{new} that have the highest gains; and
after said performing an outer iterative process, outputting H wherein the outputted H is the k output scenarios.

10. The computer program product of claim 9, wherein said determining the array H_{new} comprises:
setting H_{new} to Null;
performing an inner iterative process over inner iterations j from j=1 to j=J, wherein J=SIZE(H), and wherein the inner iterative process comprises for iteration j (j=1, . . . , J):
if H is Null then setting an array S to Null else setting S to S=H(j);
performing TopMarginalAnalysis (I, P, β, k, S) which outputs an array M having k elements structured as M₁, . . . , Mₖ, wherein each element Mₙ of M is one or more tasks Qₙ in the pool P and an associated gain Gₙ (n=1, . . . , k); and
updating H_{new} according to H_{new}=H_{new}∪{S+Qₙ∀Qₙ∈M}.

11. The computer program product of claim 10, wherein said performing TopMarginalAnalysis (I, P, β, k, S) comprises:
receiving inputs I, P, β, k, and S;
computing array Q via Q=S\textcircled{★}(P\S);
computing and storing gain array G=β(I\\Q); Q=[Q₁, . . . , Q_{N}] and G=[G₁, . . . , G_{N}];
generating array M=[M₁, . . . , M_{N})]=[(Q₁,G₁), . . . , (Q_{N},G_{N})];
reorganizing M to retain only those elements Mₙ of M that have the top k gains in G, resulting in the reorganized array M consisting of k elements; and
returning M.

12. The computer program product of claim 11, wherein said performing TopMarginalAnalysis (I, P, β, k, S) further comprises:
after said computing array Q and before said computing and storing gain array G, removing from Q each element of Q that was previously computed and stored.

13. The computer program product of claim 8, wherein said generating the pool P of C candidate tasks comprises:
receiving a critical path of tasks;
identifying a feature vector for each task on the critical path;
applying cluster analysis to the feature vectors to generate multiple clusters of tasks; and
generating the pool P of C candidate tasks from the generated multiple clusters.

14. The computer program product of claim 8, wherein said generating the pool P of C candidate tasks comprises:
extracting an initial set of tasks from the initial scheduling instance;
receiving a reduced set of tasks selected from the initial set of tasks;
identifying a first feature vector for each task in the initial set of tasks;
identifying a second feature vector for each task in the reduced set of tasks;
for each first feature vector, computing an aggregate similarity score between the first feature vector and all of the second feature vectors; and
selecting the top C tasks in the initial set of tasks in dependence on the computed aggregate similarity scores, to form the pool P of C candidate tasks.

15. A computer system, comprising one or more processors, one or more memories, and one or more computer readable hardware storage devices, said one or more hardware storage devices containing program code executable by the one or more processors via the one or more memories to implement a method for determining keywords from raw data, said method comprising:
generating, by the one or more processors, a pool P of C candidate tasks of a work process characterized by an initial scheduling instance I comprising T tasks, wherein each task of the T tasks is a job to be performed and constrains associated with the job, and wherein C is at least 3 and T>C;
generating, by the one or more processors, k output scenarios, wherein each output scenario includes b tasks selected from the pool P, wherein b<C, b is at least 2, and k is at least 2;
generating, by the one or more processors, both a modified schedule instance (MSI) for each output scenario and key performance indicators (KPIs) associated with each MSI;
outputting, by the one or more processors, the generated MSIs and KPIs;
selecting or receiving a selection of, by the one or more processors, one MSI of the generated MSIs; and
performing by the one or more processors, the work process in accordance with the selected one MSI, wherein the KPIs associated with the selected one MSI improves the work process.

16. The computer system of claim 15, wherein said generating k output scenarios comprises:
receiving input of I, P, β, k, and b, wherein β is a blackbox optimizer;
setting an array H to Null;
performing an outer iterative process over outer iterations t from t=1 to t=b, wherein the outer iterative process comprises: determining an array H_{new} of subsets of tasks in P and a gain associated with each subset of tasks in H_{new}, wherein said determining the array H_{new} is performed in dependence on I, β, k, and H; and setting H to be an array of k elements of H_{new} that have the highest gains; and
after said performing an outer iterative process, outputting H wherein the outputted H is the k output scenarios.

17. The computer system of claim 16, wherein said determining the array H_{new} comprises:
setting H_{new} to Null;
performing an inner iterative process over inner iterations j from j=1 to j=J, wherein J=SIZE(H), and wherein the inner iterative process comprises for iteration j (j=1, . . . , J):
if H is Null then setting an array S to Null else setting S to S=H(j);
performing TopMarginalAnalysis (I, P, β, k, S) which outputs an array M having k elements structured as M₁, . . . , Mₖ, wherein each element Mₙ of M is one or more tasks Qₙ in the pool P and an associated gain Gₙ (n=1, . . . , k); and
updating H_{new} according to H_{new}=H_{new}∪{S+Qₙ∀Qₙ∈M}.

18. The computer system of claim 17, wherein said performing TopMarginalAnalysis (I, P, β, k, S) comprises:
receiving inputs I, P, β, k, and S;
computing array Q via Q=S\textcircled{★}(P\S);
computing and storing gain array G=β(I\\Q); Q=[Q₁, . . . , Q_{N}] and G=[G₁, . . . , G_{N}];
generating array M=[M₁, . . . , M_{N})]=[(Q₁,G₁), . . . , (Q_{N},G_{N})];
reorganizing M to retain only those elements Mₙ of M that have the top k gains in G, resulting in the reorganized array M consisting of k elements; and
returning M.

19. The computer system of claim 18, wherein said performing TopMarginalAnalysis (I, P, β, k, S) further comprises:
after said computing array Q and before said computing and storing gain array G, removing from Q each element of Q that was previously computed and stored.

20. The computer system of claim 15, wherein said generating the pool P of C candidate tasks comprises:
receiving a critical path of tasks;
identifying a feature vector for each task on the critical path;
applying cluster analysis to the feature vectors to generate multiple clusters of tasks; and
generating the pool P of C candidate tasks from the generated multiple clusters.
